(19) United States
(12) Patent Application Publication
(10) Pub. No.: US 2016/0232003 A1
(43) Pub. Date: Aug. 11, 2016

(54) MONITORING ASPECTS OF ORGANIZATIONAL CULTURE FOR IMPROVING AGILITY IN DEVELOPMENT TEAMS

(71) Applicant: Lakshminarayana Kompella, Hyderabad (IN)

(72) Inventor: Lakshminarayana Kompella, Hyderabad (IN)

(73) Assignee: CA, INC., New York, NY (US)

(21) Appl. No.: 14/618,084

(22) Filed: Feb. 10, 2015

(51) Int. Cl. G06F 9/44; G06Q 10/06

(52) U.S. Cl. CPC G06F 8/77; G06Q 10/06393

(57) ABSTRACT

A method includes receiving a plurality of assigned procedures designed to assist a development team of an organization in completing a development project to produce a deliverable software product. The method also includes determining a set of completed procedures, by determining which of the plurality of assigned procedures were implemented by the development team during the development project. The method further includes receiving survey information from the development team indicative of an estimated impact of the set of completed procedures on a culture of the organization, and determining a metric indicating compliance with agile software development criteria for the development team based the set of completed procedures and the plurality of assigned procedures. The method still further includes receiving a customer evaluation of the deliverable software product, and determining a plan for modifying the plurality of assigned procedures to improve future customer evaluations based on the survey information and the metric.

### BACKGROUND

The disclosure relates generally to monitoring organizational culture, and specifically to monitoring aspects of organizational culture for improving agility in development teams.

### SUMMARY

According to one embodiment of the disclosure, a method includes receiving a plurality of assigned procedures designed to assist a development team of an organization in completing a development project to produce a deliverable software product. The method also includes determining a set of completed procedures, by determining which of the plurality of assigned procedures were implemented by the development team during the development project. The method further includes receiving survey information from the development team indicative of an estimated impact of the set of completed procedures on a culture of the organization, and determining a metric indicating compliance with agile software development criteria for the development team based the set of completed procedures and the plurality of assigned procedures. The method still further includes receiving a customer evaluation of the deliverable software product, determining a plan for modifying the plurality of assigned procedures to improve future customer evaluations based on the survey information and the metric, and modifying at least some of the plurality of assigned procedures based on the plan.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a system for monitoring aspects of organizational culture for improving agility in development teams in accordance with a particular non-limiting embodiment of the present disclosure.

FIG. 2 illustrates a flow chart of a method for monitoring aspects of organizational culture for improving agility in development teams in accordance with a particular non-limiting embodiment of the present disclosure.

FIG. 3 illustrates a high level flow chart for implementing agile processes in an organization in accordance with a particular non-limiting embodiment of the present disclosure.

FIG. 4 illustrates a diagram describing manifestations of organizational culture in accordance with a particular non-limiting embodiment of the present disclosure.

FIG. 5 illustrates a flow chart for monitoring and analyzing organizational culture changes produced by agile processes in accordance with a particular non-limiting embodiment of the present disclosure

FIG. 6 illustrates a methodology for collecting information from development team members and stakeholders regarding organizational culture and adherence to agile processes in accordance with a particular non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Agile methods are highly regarded by project managers, developers, engineers, officers, customers, and virtually every other participant in the software development lifecycle. Agile development methodologies are adept at handling the turbulence and unpredictability of software development cycles. That is to say, agile processes are more responsive to change and thus more effective at dealing with current development challenges.

Software development in the information systems (IS) context is often dependent on a relationship between a customer and a supplier. For example, a customer often outsources development of a system to a contractor with special expertise. The customer may issue requirements which require time-consuming negotiations between stakeholders in order to determine their priorities. It is often the abundance and prioritization of priorities that is the problem in evolutionary development, rather than the identification and elicitation of requirements. Agile methods may perform better in terms of speed, efficiency, and quality of development than traditional development methods in projects with an abundance of requirements.

The teachings of the present disclosure focus on particular aspects of agile methods that may facilitate an abundance of productivity within software development cycles or iterations. One focus of the present disclosure is the relationship between organizational culture and deployment of agile methods. The research in this area has traditionally focused on organizational culture in the context of traditional software development methodologies. The teachings of the present disclosure may define systems and methods for studying and implementing changes in organizational culture to improve project success in teams using agile development methodologies.

Software development project success depends on a variety of factors. One important but often overlooked factor that dramatically affects project success is organizational culture. Organizational culture manifests itself in a variety of ways. For example, organizational culture may include written work product, documentation, or artifacts, beliefs, assumptions, values, communication structures, behavioral paradigms, expectations, social norms, and the like. The teachings of the present disclosure may focus on several areas of organizational culture in order to better understand this powerful and vast dynamic within groups. The teachings of the present disclosure may distinguish three levels of organizational culture. The first level focuses on basic assumptions of team members. In other words, this level attempts to narrow in on what team members take for granted when beginning a given project. The next level focuses on physical artifacts and manifestations of organizational culture, such as work product, documents, visible and audible patterns, and behavioral dynamics. The final level includes core values and beliefs. This level focuses on members' thoughts concerning what ought to be done in a given scenario, or what behaviors or actions are important, beneficial, or virtuous for a given product.

In certain embodiments of the present disclosure, agile methods are approached from a two-fold view regarding the definition of Agility. For example, Agility can be regarded as having various concepts embedded within. There are many definitions of Agility. One particular definition regards Agility as meaning the readiness of an information systems development method to rapidly or inherently create change, proactively or reactively embrace change, and learn from change while contributing to perceived customer value (economy, quality, and simplicity), through its collective components and relationships with its environment. Thus, Agility can be defined as containing several components.

One component of Agility is a priori characteristics. That is to say, agile concepts include some essential notions of adaptive or reactive capacity for changes. For example, agile development teams must be nimble and not wedded to one particular design concept, structure, or any fixed set of requirements. These concepts are true irrespective of customer experience. That is to say, this component of Agility is concerned with how to best carry out a development project at the onset. It is forward looking, rather than consequential. Prospective, rather than retrospective. Taken from the example definition of Agility recited above, the a priori concepts include “the readiness of an information systems development method to rapidly or inherently create change, proactively or reactively embrace change, and learn from change.”

Another component of Agility is defined as emergent characteristics. These characteristics are dependent on experience. Taken from the example definition recited above, the emergent characteristics include “contributing to perceived customer value (economy, quality, and simplicity).

Thus, any measure of Agility, regardless of the particular definition used to define it, may include a priori and emergent characteristics. The final portion of the example definition of Agility recited above includes accomplishing the above recited elements “through its collective components and relationships with its environment.” Accordingly, in order to effectuate Agility in an organization, a priori and emergent Agility characteristics must be implemented within team structures and relationships with the organizational environment. This element may be characterized as organizational culture. Accordingly, organizational culture is a key aspect of Agility. Additionally, organizational culture is a key aspect in effectuating a priori and emergent aspects of agility within an organization.

The teachings of the present disclosure present systems and methods for retrieving, implementing, analyzing, and modifying agile processes within an organization in order to improve organizational culture and improve Agility in development teams.

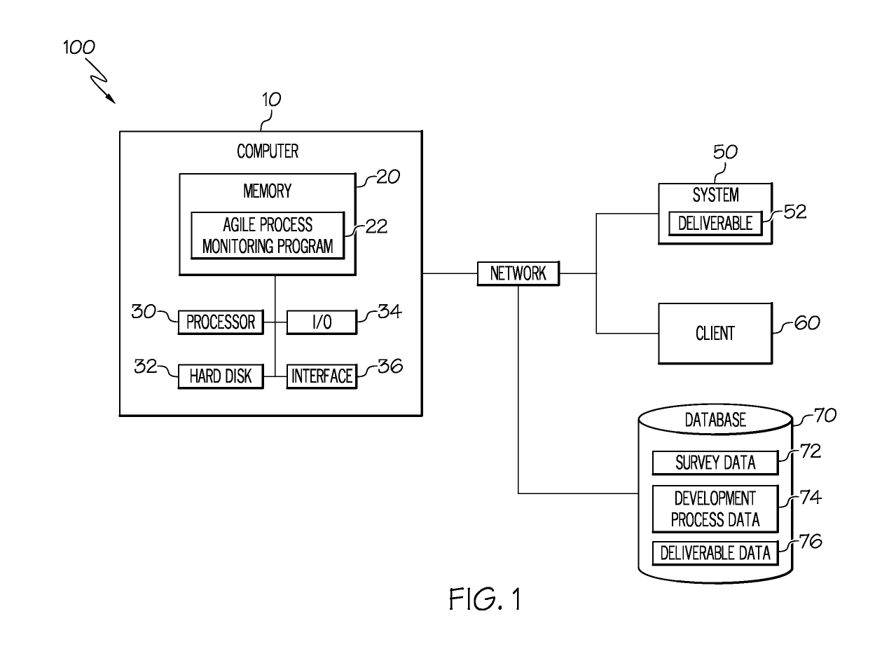

With reference to FIG. 1, a system 100 for monitoring aspects of organizational culture for improving agility in development teams is illustrated in accordance with one particular embodiment of the present disclosure. System 100 includes a computer 10, network, system 50, client 60, and database 70. Client 60 may be operated by a user to input survey information regarding group dynamics and/or social interactions and may be operated by a client to input evaluation data regarding a deliverable 52 hosted on system 50. For example, a development team may be contracted to provide an information system (IS) deliverable 52 for a particular client. Deliverable 52 may include requirements, planning, and various other specifications set out by the client. The client may evaluate deliverable 52 according to these criteria. Database 70 stores deliverable data 76 which may include client evaluation data.

Computer 10 includes memory 20, processor 30, hard disk 32, input/output 34, and interface 36. Memory 20 includes agile process monitoring program 22 for monitoring, analyzing, and evaluating agile development processes implemented by a team. Agile process monitoring program 22 receives assigned procedures from, for example, a project manager who desires to track his/her development team's Agility. The project manager uses client 60 to input assigned procedures for implementing Agility within the team. Agile process monitoring program 22 determines a set of completed procedures by determining which of the assigned procedures were implemented by the team during execution of the project. For example, a team is assigned an iteration of an agile project. The team may be presented with each assigned agile procedure. For example, a daily scrum meeting may be assigned to the members of the team. The team members may track each completed scrum meeting using agile process monitoring program 22. In certain embodiments, the team may complete a survey periodically, or at the completion of the iteration in which they respond with how many scrums they attended. The agile process monitoring program 22 may use any additional methods of tracking or monitoring progress of a development team.

Surveys may additionally serve to retrieve information about organizational culture from team members. For example, questions designed to capture beliefs, values, assumptions, and trust of the team may be administered as a survey. As another example, surveys may request written work product such as product documentation or design notes. In certain embodiments, surveys may request information involving physical behavioral characteristics of team members. The survey information may additionally request the perceived effect of any of the aforementioned processes on organizational culture.

Agile process monitoring program 22 determines an agility score for the development team based on the tracked information and the survey data. An agility score may refer to a metric indicating compliance with agile software development criteria. For example, one agile software development criteria may be to conduct face to face meetings on a daily basis. The agility score may be an evaluation of the criteria and may be measured or gauged as a metric. A customer evaluation is also retrieved from a customer regarding deliverable 52. The customer evaluation may also include information including economic data, customer satisfaction data, and the like.

Agile process monitoring program 22 may use survey data, evaluation data, and the agility score to determine a plan for modifying the plurality of assigned procedures to modify organizational culture in order to improve future customer evaluations. Agile process monitoring program 22 may implement the modifications for the next iteration. Thus, the system 100 may collectively monitor aspects of the agile process implementation, and utilize a priori aspects of Agility, emergent aspects of Agility, and organizational culture in modifying the agile process implementation in order to achieve greater Agility and improve customer feedback.

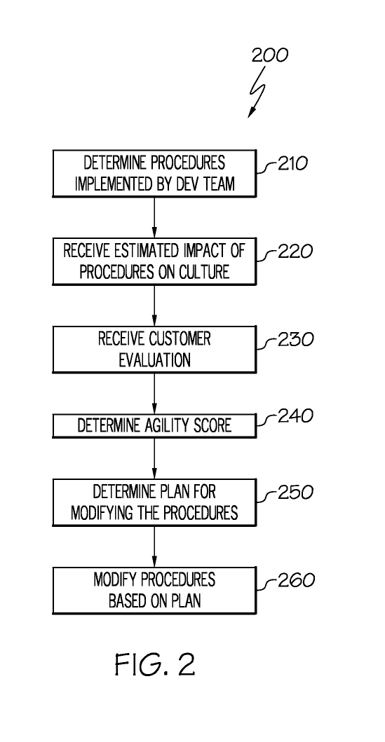

With reference to FIG. 2, a flow-chart 200 of a method for monitoring aspects of organizational culture for improving agility in development teams is illustrated in accordance with a non-limiting embodiment of the present disclosure. At step 210, procedures implemented by a development team are determined. For example, a project manager may input particular procedures that the development team is assigned to complete during the course of the software development lifecycle or iteration. The system may determine, either by monitoring and/or by manual input, which of the assigned procedures have been completed. For example, the system may track completion of various tasks assigned to the development team by monitoring the development team activities on a daily basis. As another example, the development team may complete a survey that contains information regarding the thoroughness with which they followed the assigned procedures. The system may use this information to determine procedures that were implemented by the development team.

At step 220, an estimated impact of the procedures on organizational culture is received. In certain embodiments, a survey is administered to members of a development team or any other members of the organization or client. The survey may contain questions that are designed to elicit information regarding the organizational culture. For example, if the organization punishes team members for working from home, but team members indicate they work most effectively or efficiently from home, the survey may capture these discrepancies that may foster a less than optimal organizational culture. Many other discrepancies between beliefs, assumptions, motivations, behavioral constructs of team members and organizational hierarchy may emerge as a result of these surveys. Further, the surveys may also assist the system in monitoring completion of agile development procedures by the team.

At step 230 a customer evaluation is received. The customer evaluation may be based on delivery of a software deliverable, or any other type of project deliverable. For example, the customer may evaluate the delivered software product with respect to its effectiveness at completed established requirements. The customer may evaluate the product with respect to the cost efficiency of the project, the time allocated to completion of the project, the timeliness of the delivery date of the project, the number of defects or errors in the software project, the amount by which the delivered product exceeded customer expectations, and the like. Many other criteria may be used as a basis by which the customer may evaluate the delivered software product.

At step 240, an agility score for the development project is determined. The agility score may refer to how strictly the development team followed the set of procedures that were assigned to it. The agility score may also take into consideration other information, such as the ability of the team to react to and successfully adapt to change. The agility score may additionally have a component regarding customer satisfaction.

At step 250, a plan for modifying the procedures is determined. The plan may be designed to result in an improvement of one or more of the agility score and/or the customer evaluations. The plan may include modifying aspects of the assigned procedures. For example, daily face to face scrum meetings may be removed from the calendar based on intense feedback from developers. As another example, managers may determine policies designed to keep developers in the office are too restrictive. Notice, these examples may directly relate to organizational culture. That is to say, improving group dynamics by fleshing out detrimental constructs and facilitating communication between hierarchical levels in an organization may improve organizational culture. Thus, by modifying assigned processes, organizational culture may be positively impacted. It follows that customer evaluations may improve as a result of the improvement in organizational culture.

At step 260, the assigned procedures are modified according to the plan. In certain embodiments, the assigned procedures are automatically modified based on the received information in order to improve one or more of the agility score and/or future customer evaluations. In certain embodiments, the modification of these procedures is a manual process and is effectuated by a project manager or the like.

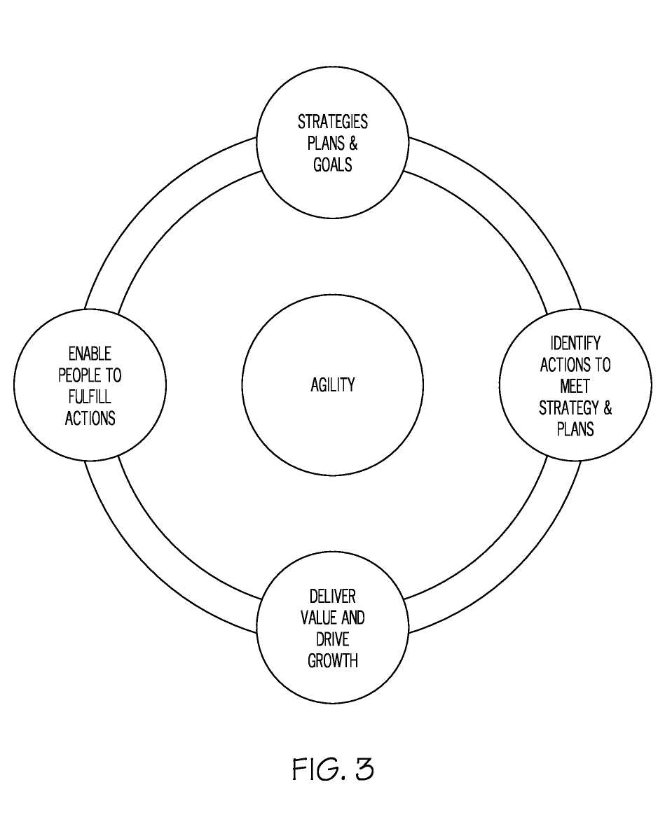

With reference to FIG. 3, a high level flow chart for implementing agile processes in an organization is illustrated in accordance with a particular non-limiting embodiment of the present disclosure. At a certain level, all agile processes include phases. The various phases of one example implementation of agile development processes are illustrated in FIG. 3. The phases of FIG. 3 include strategy planning and goal planning, identifying actions to meet those plans and goals, delivering value and driving growth, and enabling members to fulfill actions.

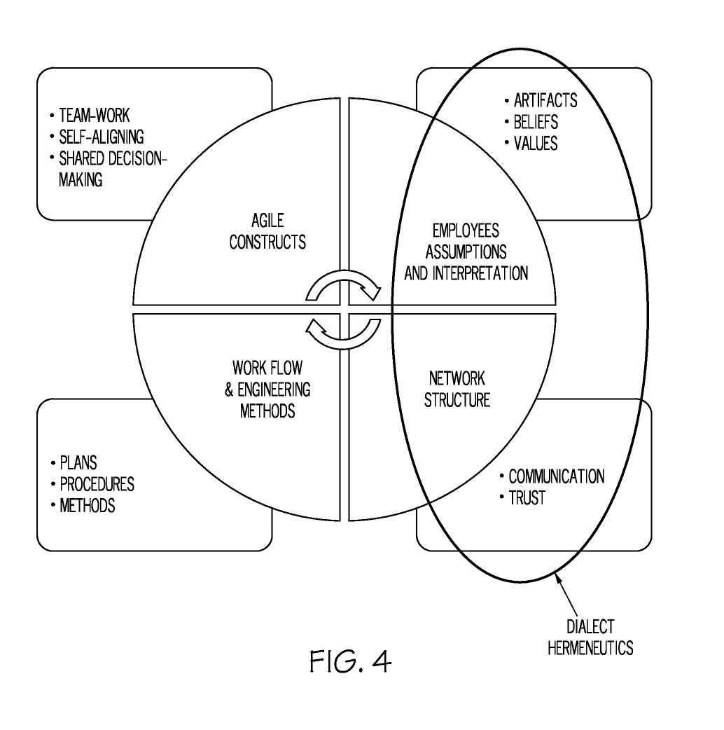

With reference to FIG. 4, a diagram describing manifestations of organizational culture is illustrated in accordance with a non-limiting embodiment of the present disclosure. These manifestations are described above in further details. The manifestations of a priori agile constructs as referenced in the top left box represent team-work, self-aligning, and shared decision-making. Each employee, regardless of technical aptitude or performance history, enters a project with assumptions. The teachings of the present disclosure help to bring those hidden assumptions to the surface in the form of analyzing manifestations of those employees.

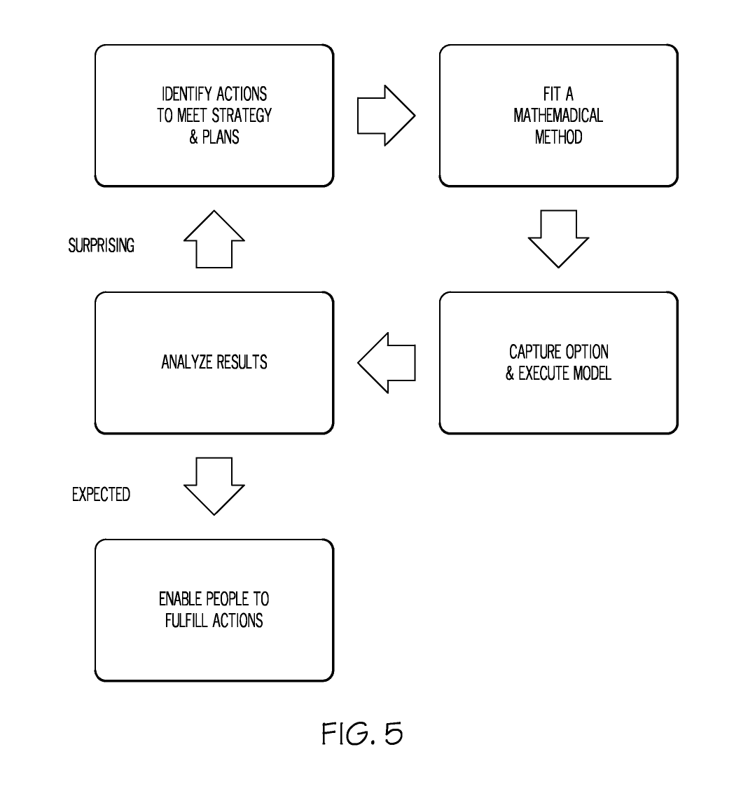

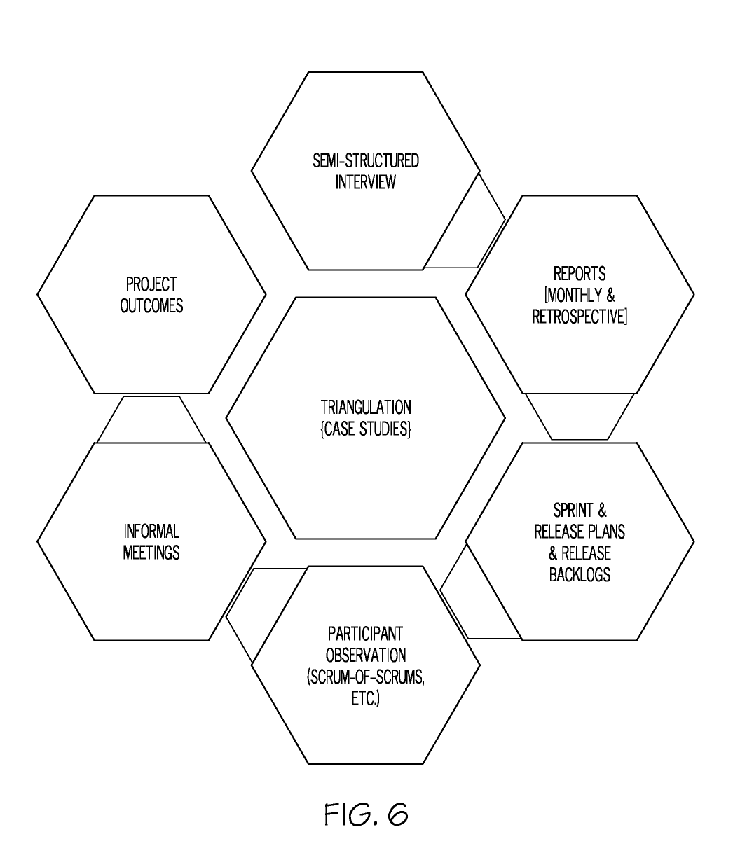

With reference to FIGS. 5 and 6, flow charts for monitoring and analyzing organizational culture and collecting information regarding organizational culture are illustrated in accordance with a non-limiting embodiment of the present disclosure.

Traditional development methodologies focused on the rationalization of software development efficiency. For example, these methods tended to focus on measuring productivity, efficiency, and goal achievement. Order and methodologies were embraced which resulted in a hierarchical culture. However, discrepancies often arose between development team members, who were motivated by producing high quality software, and those higher up in the organizational hierarchy, who were motivated by meeting milestones and economic efficiency. Thus, when agile methods were introduced, it is not surprising that it was so well received by practitioners. One big reason is the shift from eliminating change (i.e., planning and sticking to the plan from beginning to end) to embracing change. This is often referred to as emergent development and the emergent property of agility. For example, in agile development processes, components with business value are built one piece at a time on top of each other. Planning for future iterations may not conducted until it is time to build that piece. Thus, functioning software is delivered at the conclusion of each iteration, and plans change in order to accommodate emergent properties of the project. The design of the completed project is emergent and develops as each iteration is completed.

While agile methods created intense interest and enthusiasm in practitioners when first introduced, changes to IS development were less encouraging. This may be because the requirements elicitation process, which is a requirement of IS development, is not well suited to resolution with agile methods. For example, in traditional IS development, the customer is expected to clarify requirements, which often includes complex negotiations between stakeholders as requirements are fleshed out.

Development teams and IT managers may be out of synch with respect to organizational issues. For example, IT managers tend to focus on productivity, efficiency, and achievement of goals while developers are not motivated by such factors. When these issues between agile development teams and IT managers are addressed, agile methods that lead to project success can be better understood.

In order to address this discrepancy, agile processes implemented within projects should be observed. However, agile processes should be observed as, not only a prior characterization of agile methods, but also as an emergent property. For example, observing emergent properties of agile processes should include considering economic factors and software quality. Observation of emergent properties of Agility may address organizational issues and may also provide opportunities to study unique combinations of various elements of a project, including organizational culture.

The teachings of the present disclosure reference qualitative research conducted through multiple case studies consisting of three releases of a single development team. The data discussed herein with respect to several particular embodiments of the present disclosure was collected using the participant-observation method. The findings have identified some useful insights that could help researchers and practitioners in developing new software development lifecycles that incorporate existing agile methods and use a diverse set of methods to resolve issues. Problems with organizational culture are one of these issues that may be benefited and/or resolved by the teachings of the present disclosure.

Certain studies have found that no empirical relationship exists between project success and agile development methods. For example, when organizational issues that arise between agile development teams and IT managers—who focus more on productivity, efficiency, and goal achievement—are addressed, a better understanding of the project success and agile methods can be arrived at. Resolving these organizational issues can be analyzed by defining agility as an emergent property that includes project economics and software quality. However, emergent agility may not be achieved using merely prior characterizations of agile methods.

The methods outlined in the agile manifesto, i.e., favoring: (1) individuals and interactions over processes and tools, (2) working software over comprehensive documentation, (3) customer collaboration over contract negotiation, and (4) responding to change over following a plan, may be referred to herein as the prior characterization of agility because these factors characterize the traditional approach to agile software development processes. However, to create emergent agility, as described above, certain methods, plans, and processes regarding organizational culture must be implemented. Certain teachings of the present disclosure may present changes to the software development life-cycle used to develop products and provide services that enable organizations to meet re-defined goals and objectives using emergent agility constructs.

These changes involve a unique combination of light-weight methods from traditional agile software development practices and actions specific to the organizational culture of the organization. Emergent agility methods consist of approaches and/or methods that can be attempted by organizations with team groupings of varying size and scope. For example, the teachings of the present disclosure may be applied at the organization level, team level, or individual level.

In certain embodiments, the resulting combination of processes from the suggested methods results in constructs that are different than traditional agile methodologies. The teachings of the present disclosure may attempt to apply these methods to analyze agile development techniques with simple, relevant, iterative, and incremental methods for initiating corrective/preventative actions to achieve emergent agility.

Determining relationships between organizational culture and project performance may enable organizations to more effectively utilize agile processes within project teams to drive productivity. For example, one agile process involving group dynamics and social interactions may be critical to project performance among a development team, while another may have less of an impact on the performance of the development team. Identification of the most effective processes can benefit project planning and team productivity.

Once relationships between group and social processes are determined, hypothesis can be generated and tested using quantitative confirmatory methods. Project plans and projections can be made based on the results of these tests. Additionally, these tests may suggest and/or identify key processes for adoption within the organization, or within a certain team. Further, resource utilization may be planned based on the results of these tests.

The teachings of the present disclosure may enable an organization to iteratively track the effects of group dynamics and social interactions on the efficiency and productivity of teams within an organization. The teachings of the present disclosure may further enable better future process adoption based on these results within teams across an organization. The effects of these processes may be tracked using a scientific approach.

In certain embodiments, the teachings of the present disclosure may be implemented in existing techniques and practices already being practiced by the team. Thus, embodiments of the present disclosure may be implemented without disrupting existing development team processes. The effects of these processes may further be tracked without requiring team members to take on any additional tasks outside the normal scope of their work.

The present disclosure may refer to teams in the context of development teams. However, the teachings of the present disclosure may be applied to any type of team, organization, group, department, or other organizational structure where group dynamic and social interaction processes may be applied. The present disclosure may also refer to agile development processes as an example. However, the teachings of the present disclosure may be applied to any team, social, or group processes that may be applied within an organization.

In certain embodiments, a predetermined amount of resources are used in implementing each team initiative in the development team. For example, an organization may spend a predetermined amount of capital or human resources on implementing certain initiatives within development teams. These initiatives may be designed to assist the team in delivering a software project to a customer by a specific date. One example team initiative may be to inculcate various agile programming practices like pair-programming, test-first, open work-area and so forth. However, these changes may cost resources. For example, frequent changes may take time and/or disrupt the work of each team member. As another example, compliance with these initiatives may include a learning curve that will even out over time. The amount of resources utilized by this initiative may be assessed and modified to increase team productivity.

As another example, an organization may enact an organization-wide initiative to decrease team member absenteeism, specifically absenteeism on or around key dates in the project schedule. An organization may spend a variety of resources on campaigns designed to increase employee wellness and stake in projects in order to decrease absenteeism. However, absenteeism may not have a significant impact on achieving project goals. In certain embodiments, the effect of this metric may be overestimated by managers and team members. Thus, the organization may be better suited spending the resources spent on this initiative on other team initiatives that may drive project goals. The teachings of the present disclosure may enable identification of these ineffective initiatives.

The present disclosure may further provide insights into how different techniques and principles of agile methods support emergent agility. Additionally, the present disclosure may provide insights into the situations that are required to achieve emergent agility. Further, cultural changes required to establish emergent agility may be identified.

In certain embodiments, a logistic regression equation may be used to identify cultural changes related to achieving a certain goal related to a project. For example, the logistic regression may have been used to measure customer propensity to buy products and/or services. As another example, the logistic regression may measure the effectiveness of particular group dynamics and social interactions on the probability that a team will meet a predetermined delivery deadline.

The teachings of the present disclosure may not require any major changes to existing activities that involve group and social interactions. However, changes may be identified that may allow a team to refine techniques and practices in future iterations to increase team productivity.

In certain embodiments, average project velocity may be used to measure the effectiveness of agile development processes. For example, teams using agile software development processes may calculate an average project velocity. Average project velocity may be used to forecast the project completion date. However, project velocity and average project velocity calculations may be limited in their ability to forecast accurate project completion dates. Additionally, these calculations may have limited utility. For example, such metrics may not measure how ongoing and dynamic changes among the project and/or development team may be affecting the velocity calculation throughout different phases of the project.

Project velocity includes a capacity planning tool that tracks the number of units of work completed in a certain time period interval. For example, project tasks may be broken up into units of work and assigned to project team members. The units of work required to complete each project task is estimated. Those tasks are distributed to team members for completion based on the estimated units of work required to complete the task.

Velocity may be calculated by counting the number of units of work that are completed during an interval. Velocity may be used to estimate the productivity of a team, and their capacity to take on future tasks.

However, the project velocity metric may not account for dynamic changes to the group. For example, the project velocity metric may not account for changes to a group initiative, team initiative, organizational initiative, group process or method, or the like. As another example, an organization may undertake a new software development method to foster collaboration, such as scheduling daily stand-up meetings. For example, the software development method undertaken by the team may be an agile process. This new process may contribute or detract from project performance. However, current development processes may not be equipped to measure the effects of such dynamic changes to the team social interactions.

In certain embodiments, decision-making, team-work, and self-aligning agile process constructs may be critical to determining necessary changes in team mindset and organization in order to improve project performance and delivery capabilities. However, difficulties may arise in measuring the effects of the implementation of such constructs within a team, as well as any additional agile constructs. For example, a team that employs a new shared decision making construct within their agile development cycle may deliver a product with fewer defects before the estimated delivery date. However, without processes in place to measure the effects of the shared decision making construct on the productivity of the team, it is not clear whether the addition of this new process harmed or hurt team performance. For example, other factors may have been responsible for the increase in productivity and effectiveness during the development cycle. In some instances, the new process may have even negatively affected team performance and efficiency. Nevertheless, managers may recognize the early product delivery as a result of the newly employed process. This mis-identification of beneficial processes may cause the organization to employ the new process in future project iterations, and may negatively impact future projects.

Software effort estimation practices may lead to inaccuracy and bias. For example, when team members are asked to estimate the impact of certain practices and constructs on productivity, they may overestimate the benefits while underestimating the risks and complexities of the practices. Such estimates may be idealized estimates, instead of realistically thought out benefits estimates.

In certain embodiments the difference between idealistic and realistic values may be reduced. In this process, the estimators may only account for the complexities and risks of development, and may exclude other biases from being reflected in the estimates. Therefore, to improve accuracy, estimates may be attempted after reducing the idealistic and realistic values.

In certain embodiments, judgment based estimation may be used. Thus, findings may be utilized to exclude range-based estimation from consideration. For example, software effort estimations based on judgment based estimation, irrespective of instructions, may not improve the range. Therefore, these estimations may exclude range-based estimation in order to improve the accuracy of the estimates and remove the biasing effect of extraneous considerations on estimates.

The teachings of the present disclosure may utilize software development effort estimation practices. Software development effort estimation may include the process of predicting the most realistic use of effort required to develop or maintain software based on incomplete and/or uncertain input. Such effort estimates may be used to plan project schedules, budget for development, and price and bid on contracts. The teachings of the present disclosure may not be limited to software development efforts estimation practices. Rather, the teachings of the present disclosure may be applied to a variety of fields where efforts estimation processes are used.

Software development effort estimation may also include a quantification step. The quantification step may include using various sources of information to develop a judgment about some future aspect of a project. For example, historical data about lines of code per man-hour may be used to predict future productivity estimates and quantify an estimate in the quantification step. As another example, an expert may predict the estimate based on various factors including experience.

In certain embodiments, group estimation may be used. Group estimation may include a consensus-based technique for an expert effort estimation process. Examples of group estimation methods used in agile software development include planning poker and Wideband Delphi methods.

Group estimation may be beneficial because one individual is not responsible as the main unit of analysis. Social interactions and group dynamics of group estimation processes may be considered. For example, the planning poker method may provide more accurate results than unstructured group estimation. Planning poker, when applied to solve complex problems, may allow multi-specialist groups in the organization to work together to produce a proper estimate.

In certain embodiments, estimation method accuracy may be improved by using any newly emerging trend or method. However, new estimation methods may not capture dynamic changes present in the project. For example, various methods and techniques may be used in the project. These methods and techniques may be dynamically swapped in and out of use during the development cycle. The teachings of the present disclosure may enable a person having ordinary skill in the art to consider dynamic changes to the project and measure those changes in order to understand estimators and group estimation assumptions. In certain embodiments, a logistic regression may help in further understanding the estimators and the group estimation assumptions.

In certain embodiments, dynamic changes may be considered and measured. A logistic regression may be run on the measurements in order to determine the estimators and group estimation assumptions.

Using, for example, Planning poker and/or other group-based agile development methods, the development team may collectively determine estimates based on assumptions. Later on in the development cycle, such as during project execution, the team may accept and/or reject changes based on the amount of quality changes that are required. The team may also accept and/or reject changes based on the possible increase in through-put.

In certain embodiments, teams may use a dialectic approach. For example, teams may discuss detracting and enabling factors that may represent independent variables. These independent variables may influence various dependent variables. In certain embodiments, the dependent variables may be considered and factored into the project schedule.

In certain embodiments, independent variables may be divided into groups. For example, the independent variables may be divided into “known-unknowns” and “unknown-unknowns”. The team may select items from the list of known-unknowns that may require attention. For example, the team may select urgent requirements or items or risks from the known-unknowns list.

In certain embodiments, the output of the selected list of independent variables may be listed. For example, the following items may be selected as requiring attention: (1) Voluntary requirement changes [X₁]; (2) Involuntary requirement changes [X₂]; (3) Quantum of unplanned additional re-work to meet quality criteria [X₃]; (4) Impediments that result out of process delays due to cross-border factors [X₄]; (5) Unavoidable absenteeism including attrition and the possible self-aligning to compensate reduction in sprint velocity when project is in flight [X₅].

In certain embodiments, such variables may be selected based on supporting factors provided by team members. Any widely used method or approach may be used to determine the list of variables. Additionally, more or less variables may be used without departing from the scope of the present disclosure.

In certain embodiments, involuntary requirement changes may reflect the possibility of communication lapses in distributed development environments. For example, communication problems may arise where resources are spread over a diverse geographic region. In certain embodiments, problems may arise due to incomplete understanding of requirements.

In certain embodiments, absenteeism may decrease project velocity. For example, if team members do not self-align to compensate, project velocity may be decreased. The questionnaire may further capture the individual team members' opinions on the possible outcomes of compensatory increase or decrease.

In certain embodiments, unknown unknowns may include, for example, organizational disruptions, and/or technological disruptions. These items may be addressed by project contingency plans.

In certain embodiments, a logistic regression model may be run on the selected list of independent variables, for example, on the values represented by the variables X₁-X₅. These independent variables may positively or negatively influence project outcome.

In certain embodiments project outcome may be measured in terms of the probability of meeting the project schedule. In certain embodiments, other ways of measuring project outcomes may be used. For example, the project outcome may be measured in terms of number of defects per thousands of lines of code (defects/KLOC).

Project outcomes may be influenced due to certain requirements or constraints. For example, resource competencies and/or incompetencies may constrain project outcomes. Inherent uncertainties may be assumed to be addressed during group estimation. For example, during group estimation, the group members may interact among themselves to arrive at estimates. These estimates may be in the form of a buffer to the effort required. In certain embodiments, these estimates may be in the form of developing prototypes for further evaluation, when the prototype is ready.

In certain embodiments, organizational cultural change initiatives may be determined. For example, these initiatives may be implemented by employees. Each organizational cultural change initiative may be associated with a goal to drive growth in products and/or services. The initiatives may also be associated with an amount of resources required to undertake that initiative. For example, the initiative may be associated with a cost to the organization of undertaking that initiative.

In many cases an optimal resource allocation or re-allocation may be required. Optimization may need to be done considering both organizational structure with its social dynamics and the team setup required for Agile software development. Agile software development emphasizes on constructs such as trust and communication among teams. Social Network Analysis (SNA) can be used to arrive at the optimal trust and communication centralities. The arrived trust and communication centralities can be used to modify organizational structure and thereby its dynamics. The modified organizational structure with enhanced trust and communication centralities will help in achieving both emergent and a prior characterization of agility.

In certain embodiments, information indicative of a possible impact of each organizational cultural change initiative on a probability that the cultural changes will achieve the goal to drive growth in products and/or services is estimated.

New organizational cultural change initiatives are applied on already existing cultural outlook. This outlook (prior probability) does influence the change initiative (set of new data). In such scenarios Bayesian Theorem or Probabilistic Neural Networks (PNN) can be applied. When such scientific methods are used for decision-making it helps in eliminating or reducing bias, identifying possible outcomes before rolling out the initiative across the entire organization and, most importantly, identify potential problematic areas that can hamper progress of new initiatives. In doing so, number of iterations required to finalize on the actions, as shown in FIG. 5, for emergent agility could be reduced.

In certain embodiments, as the project progresses, the combination of variables discussed (e.g., X₁-X₅) may positively or negatively influence the assumptions of the group. These influences may ultimately determine if the project team will be able to meet the schedule.

In certain embodiments, the variables, e.g., X₁-X₅, may represent hypothetical factors that influence project outcome. For example, a project manager and team may hypothesize that these variables are key aspects influencing project delivery, growth, and/or performance.

In certain embodiments, a questionnaire may be administered to project team members. The project members may evaluate the effect of each of the variables, alone and in combination with each of the other variables, on the project. For example, such a questionnaire may be designed to measure the impact of the listed variables on the consumer's propensity to purchase the developed software.

Such a questionnaire may include using a dichotomous nominal scale (e.g., a yes or no scale) to have each team member rate the project outcomes (i.e., the dependent variable) and the five independent variables. In certain embodiments, the impact of each independent variable on the project outcome is measured. Additionally, the impact of each combination of the independent variables may be included.

In certain embodiments, team members may be geographically distributed. For example, team members may work on a common project, but may be physically located in various offices of an international corporation.

In certain embodiments, variables that were not estimated by the group as bearing an impact on project completion may be determined to impact the probability of project completion, and vice-versa. This may be important in planning future policies and procedures to better leverage those variables that may be important with respect to project completion, or any other project goal.

For example, in the above example, the team indicated absenteeism (i.e., variable X₅) as an important factor in completing a project. As a result, policies and resources may have been deployed to motivate employees in an effort to curb absenteeism during key delivery dates. However, the regression analysis and variance tests indicate that this factor may be insignificant with respect to project completion. Resources may be directed from these efforts to more useful efforts based on these results.

Thus, an organization may use the techniques described in the present disclosure to identify key variables that impact project completion and may tailor provisioning of those resource to better achieve identified goals. For example, instead of spending organization resources on motivating employees to reduce absenteeism, those resources may be spent on improving processes designed to iron out requirements changes with the product owner and fewer changes to project requirements (i.e., variable X₁ & X₂ from the above example) are required during development.

In certain embodiments, other agile methods and processes may be identified as insignificant to project goals, such as timely completion of agile ceremonies. In the above example, scrum activities such as stand-up meetings, retrospectives, and other agility-focused activities may not be as important as management had estimated. In certain embodiments, these areas may be referred to prior characterizations of agility. Resources and attention may be distributed to other areas, such as build break-down, test set-up environments, test executions, system configurations, and other project areas that may be identified as having a significant impact on project goals. In certain embodiments, these areas may be referred to as areas contributing to emergent agility.

In certain embodiments, the degree of impact of a particular type of event, or variable, may be assessed against other events. For example, system 100 may identify three variables that have a significant impact on project schedule. However, two of those variables may have a larger impact on the project schedule than the other variable. For example, in the above example, system 100 may indicate that variables X₁, X₂, and X₃ may have a significant impact on project schedule. System 100 may provide values for each variable, indicating each variable's propensity to affect the project completion date. Such numbers may be listed as significance values. Such values allow limited organizational resources to be directed to those areas with the greatest impact on project goals.

In certain embodiments, processes may be identified and used to improve goal attainment throughout an organization. As teams identify independent variables and develop processes that handle the identified emergent agility problem areas identified by the methods described in the present disclosure, these processes may be used on an enterprise and/or organization-wide scope. These processes may become instrumental in achieving cultural changes that may improve team attainment of project goals. These cultural changes may assist organizations in deciding on how to drive growth in their products and/or services.

In certain embodiments, identification and selection of independent variables can be done using dialectical interplay. Ending the analysis here may result in selection of improper variables that do not significantly affect project goals. In certain embodiments, a questionnaire may be distributed to group members in order to collect information about group dynamics and social interactions. This information may be subject to logistic regression test variables so that significance can be identified. Thus, if an organization focuses on these variables from dialectical interplay without further processing or testing, the organization may waste resources on areas that may not significantly impact project goals. The teachings of the present disclosure may enable identification of variables that have a significant impact on project goals so that the organization may focus resources on those specific areas to improve project performance.

In certain embodiments, when agility is attempted as a combination of a priori characterization and emergent agility, deep incorporation of agility may be possible in all aspects of the software development life-cycle. Thus, in certain embodiments, continual improvement of group behavior in the software development life-cycle may be accomplished.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving a plurality of assigned procedures designed to assist a development team of an organization in completing a development project to produce a deliverable software product;
determining a set of completed procedures, by determining which of the plurality of assigned procedures were implemented by the development team during the development project;
receiving survey information from the development team indicative of an estimated impact of the set of completed procedures on a culture of the organization;
determining a metric indicating compliance with agile software development criteria for the development team based the set of completed procedures and the plurality of assigned procedures;
receiving a customer evaluation of the deliverable software product;
determining a plan for modifying the plurality of assigned procedures to improve future customer evaluations based on the survey information and the metric; and
modifying at least some of the plurality of assigned procedures based on the plan.

2. The method of claim 1, wherein the customer evaluation comprises:
an economic efficiency rating of the development project; and
a software quality rating of the deliverable software product.

3. The method of claim 1, wherein the survey information comprises, for each member of the development team:
a ranking of attributes for success in development projects;
an evaluation of physical behavioral patterns of the development team; and
an evaluation of communication mechanisms within the development team.

4. The method of claim 1, wherein determining the metric further comprises comparing a first quantity of procedures in the set of completed procedures and a total quantity of procedures in the plurality of procedures.

5. The method of claim 1, wherein the metric is further based on:
results of testing the deliverable software product for quality; and
the set of completed procedures.

6. The method of claim 1, wherein the culture of the organization comprises:
assumptions of members of the organization;
physical behavior patterns of the members of the organization; and
values of the members of the organization.

7. The method of claim 1, wherein the plan for modifying the plurality of assigned procedures is designed to improve the organizations ability to adapt to changes in the development project.

8. A computer configured to access a storage device, the computer comprising:
a processor; and
a non-transitory, computer-readable storage medium storing computer-readable instructions that when executed by the processor cause the computer to perform:
receiving a plurality of assigned procedures designed to assist a development team of an organization in completing a development project to produce a deliverable software product;
determining a set of completed procedures, by determining which of the plurality of assigned procedures were implemented by the development team during the development project;
receiving survey information from the development team indicative of an estimated impact of the set of completed procedures on a culture of the organization;
determining an metric indicating compliance with an agile software development criteria for the development team based the set of completed procedures and the plurality of assigned procedures;
receiving a customer evaluation of the deliverable software product;
determining a plan for modifying the plurality of assigned procedures to improve future customer evaluations based on the survey information and the metric; and
modifying at least some of the plurality of assigned procedures based on the plan.

9. The computer of claim 8, wherein the customer evaluation comprises:
an economic efficiency rating of the development project; and
a software quality rating of the deliverable software product.

10. The computer of claim 8, wherein the survey information comprises, for each member of the development team:
a ranking of attributes for success in development projects;
an evaluation of physical behavioral patterns of the development team; and
an evaluation of communication within the development team.

11. The computer of claim 8, wherein determining the metric further comprises comparing a first quantity of procedures in the set of completed procedures and a total quantity of procedures in the plurality of procedures.

12. The computer of claim 8, wherein the metric is further based on:
results of testing the deliverable software product for quality; and
the set of completed procedures.

13. The computer of claim 8, wherein the culture of the organization comprises:
assumptions of members of the organization;
physical behavior patterns of the members of the organization; and
values of the members of the organization.

14. The computer of claim 8, wherein the plan for modifying the plurality of assigned procedures is designed to improve the organizations ability to adapt to changes in the development project.

15. A computer program product comprising:
a computer-readable storage medium having computer-readable program code embodied therewith, the computer-readable program code comprising:
computer-readable program code configured to receive a plurality of assigned procedures designed to assist a development team of an organization in completing a development project to produce a deliverable software product;
computer-readable program code configured to determine a set of completed procedures, by determining which of the plurality of assigned procedures were implemented by the development team during the development project;
computer-readable program code configured to receive survey information from the development team indicative of an estimated impact of the set of completed procedures on a culture of the organization;
computer-readable program code configured to determine a metric indicating compliance with agile software development criteria for the development team based the set of completed procedures and the plurality of assigned procedures;
computer-readable program code configured to receive a customer evaluation of the deliverable software product;
computer-readable program code configured to determine a plan for modifying the plurality of assigned procedures to improve future customer evaluations based on the survey information and the metric; and
computer-readable program code configured to modify at least some of the plurality of assigned procedures based on the plan.

16. The computer program product of claim 15, wherein the customer evaluation comprises:
an economic efficiency rating of the development project; and
a software quality rating of the deliverable software product.

17. The computer program product of claim 15, wherein the survey information comprises, for each member of the development team:
a ranking of attributes for success in development projects;
an evaluation of physical behavioral patterns of the development team; and
an evaluation of communication within the development team.

18. The computer program product of claim 15, wherein determining the metric further comprises comparing a first quantity of procedures in the set of completed procedures and a total quantity of procedures in the plurality of procedures.

19. The computer program product of claim 15, wherein the metric is further based on:
results of testing the deliverable software product for quality; and
the set of completed procedures.

20. The computer program product of claim 15, wherein the culture of the organization comprises:
assumptions of members of the organization;
physical behavior patterns of the members of the organization; and
values of the members of the organization.
